(19) United States
(12) Patent Application Publication
(10) Pub. No.: US 2015/0330708 A1
(43) Pub. Date: Nov. 19, 2015

(54) FURNACE CONTROL FOR MANUFACTURING STEEL USING SLAG HEIGHT MEASUREMENT AND OFF-GAS ANALYSIS SYSTEMS

(71) Applicant: NUCOR CORPORATION, Charlotte, NC (US)

(72) Inventor: Daniel J. Brisson, Avon, IN (US)

(73) Assignee: NUCOR CORPORATION, Charlotte, NC (US)

(21) Appl. No.: 14/280,057

(22) Filed: May 16, 2014

(51) Int. Cl. F27D 21/00; F27D 11/08; F27D 19/00; C21C 5/52

(52) U.S. Cl. CPC F27D 21/0028; C21C 5/52; F27D 11/08; F27D 19/00; F27D 2019/0015

(57) ABSTRACT

Embodiments of the invention comprise measuring the slag height level using a slag height level measurement system, as well as analyzing the off-gas components in a furnace using an off-gas analysis system in order to more efficiently control the furnace during a steelmaking process. The slag height level measurement system and the off-gas analysis system may be utilized to determine when the scrap steel has melted, when the slag height level has decreased, and if the slag height level has decreased due to deficient carbon and/or oxygen, or excess carbon and/or oxygen in the furnace.

### FIELD

The present invention is related to the field of manufacturing steel in a furnace, and more particularly manufacturing steel in an electric arc furnace (EAF) through the use of a slag height level measurement system and an off-gas analysis system.

### BACKGROUND

Furnaces, and in particular electric arc furnaces (EAFs) are used to manufacture steel by receiving one or more charges of scrap steel and melting the scrap steel using arcs from the electrodes within the EAF. During the manufacture of steel, carbon (e.g., through carbon injectors) and process gases, such as oxygen, (e.g. through the use of natural gas and/or O₂ injectors) are injected into the furnace, in part in order to support slag foaming during the manufacture of steel. The height of the slag foam covering the inside of the EAF walls, roof, and electrodes and the consistency of the slag improves the efficiency of energy consumption, reduces damage to the internal components of the EAF, and reduces arc noise created by vibrations of the EAF due to the electrodes. The solid steel, molten steel, and slag foam height and consistency cannot be visually inspected from outside of the EAF, and as such, inefficiencies occur in the electric energy used to power the electrodes, as well as inefficiencies in the amount of carbon, natural gas, and oxygen injected into the EAF when they are not needed during the steel manufacturing process.

### SUMMARY OF THE EMBODIMENTS OF THE INVENTION

The following presents a simplified summary of one or more embodiments of the present invention, in order to provide a basic understanding of such embodiments. This summary is not an extensive overview of all contemplated embodiments, and is intended to neither identify key or critical elements of all embodiments nor delineate the scope of any or all embodiments. Its sole purpose is to present some concepts of one or more embodiments of the present invention in a simplified form as a prelude to the more detailed description that is presented later.

Embodiments of the invention comprise measuring the slag height level (referred to herein interchangeably as slag height, slag level, slag height level, or the like) using a slag height level measurement system, as well as analyzing the off-gas components (e.g., CO, CO₂, H₂O, outlet temperature, or the like) in the EAF using an off-gas analysis system in order to more efficiently control the EAF during the steelmaking process. In some embodiments of the invention, the slag height level measurement system comprises a vibration sensor system, such as but not limited to using vibration sensors located on surfaces of the EAF. One embodiment of a vibration system is the SonArc system provided by Siemens Industry Inc., which utilizes vibration sensors (e.g., 3 sensors) on the wall of the EAF to determine the slag height level, as described in further detail below. In other embodiments of the invention other types of vibration systems may be utilized to measure slag height level within the EAF, such as but not limited to systems that have vibration sensors mounted directly on the electrodes to correlate electrode vibrations with various slag height levels. It should be understood that other types of slag height level measurement systems may be utilized that provide a way of defining the slag height level within the EAF.

The off-gas analysis system may be a system that measures the off-gas components exiting the EAF in real-time or near real-time (e.g., within 1-3 seconds, 1-5 seconds, 1 to 10, 15, 20, 25, or 30 seconds, 1 second to a minute, or other ranges inside, overlapping with, or outside of these ranges). However, in some embodiments of the invention it is important to get a reading of the off-gas within 10, 9, 8, 7, 6, 5, 4, 3, 2, or 1 second, or instantaneously in order to be able to react as necessary in order to alter the control of the EAF to reduce inefficiencies. In one embodiment of the invention the off-gas analysis system may comprise an off-gas laser analysis system that takes measurements of the off-gas of the EAF near an exit of the EAF (e.g., at the 4^{th} hole or other exit in the EAF roof, the exhaust duct near the 4^{th} hole or other exit, or the like) in order to provide instant feedback of the off-gas exiting the EAF in real-time or near real-time. The off-gas analysis system in the present invention provides real-time or near-real time feedback of the off-gas instead of having to take samples of the off-gas downstream or use other downstream measurement systems (e.g., infrared systems, or the like) that are not able to handle the conditions near the EAF, and thus, do not provide off-gas analysis feedback in real-time or near real time. In some embodiments of the invention the off-gas laser system is a ZoloBOSS system from Zolo Technologies Inc., which is described in further detail below. In other embodiments of the invention other types of off-gas laser systems or other types of off-gas analysis systems may be utilized to analyze the off-gas exiting the EAF near the off-gas exit in the EAF. It should be understood that these other types of off-gas analysis systems may be utilized to provide a way of providing off-gas analysis in real-time or near real-time.

Generally, as is described in further detail later, the slag height level measurement system is used to determine if the slag height level is at, above, or below a slag height threshold level (e.g., a single slag height threshold level, a threshold range, or the like) throughout the entire steelmaking process, during specific intervals within the steelmaking process, or at certain points in time during the steelmaking process. The slag height threshold level may be defined as a height within the EAF in which the slag covers the walls, electrodes, roof, or the like for achieving the desired efficiency of energy consumption, reducing damage to the internal components of the EAF, and reducing vibrations created by the electrodes in the EAF. As such, if the slag height level is at or above the slag height threshold level, the inputs into the steelmaking process may not need adjusting. If the slag height level is too high (e.g., slag is coming out of the EAF such as through the electrode holes, off-gas exit, lid, slag door, or the like) carbon and oxygen injection into the EAF is reduced, as will be discussed in further detail later. Alternatively, if the slag height level is below a slag height threshold level, it may be caused by a number of factors. For example, there may be too much oxygen (O₂) in the EAF, which would cause the slag to be runny (e.g., low viscosity), and thus not foam as desired. There may be too much carbon (C) in the EAF, which would cause the slag to be thick (e.g., high viscosity), and thus not foam as desired. There may not be enough oxygen in the EAF, which would also cause the slag to be too thick (e.g., high viscosity), and thus not foam as desired. Finally, there may not be enough carbon in the EAF, which would also cause the slag to be too runny (e.g., low viscosity), and thus not foam as desired. Other factors in the steel making process may have an impact on the slag height of the foamy slag.

In the present invention, analyzing the off-gas when the slag height is below a slag height threshold level may help to determine if carbon, oxygen, or both need to be added, increased, reduced, or stopped in order to improve slag foaming within the EAF. Moreover, analyzing the off-gas and slag height in real-time or near real-time allows for the ability to make these adjustments to the EAF inputs (e.g., electrode power, carbon injection, oxygen injection, or natural gas input injection, or the like) quickly in real-time or near-real time in order to greatly improve the efficiency of the EAF and reduce the resources utilized by the EAF during the steelmaking process. In other embodiments of the invention, analyzing the off-gas and slag height captured in real-time or near real-time over two or more heats allows for the ability to make adjustments to the EAF inputs profiles (e.g., pre-programmed inputs determined before a heat begins).

In one embodiment, the amount of carbon monoxide (CO) in the off-gas may be used to determine how to adjust the carbon or oxygen injection into the EAF. For example, if the slag height is below a slag height threshold level and if the carbon monoxide (CO) determined in the off-gas is at or above the carbon monoxide threshold levels, then enough carbon is reacting with enough oxygen (or vice versa), and as such there is too much carbon or too much oxygen in the EAF (e.g., slag is either too thick with too much carbon or too runny with too much oxygen). In response, the carbon and/or oxygen can be reduced and the carbon monoxide and slag height level monitored to determine if the carbon monoxide remains above a carbon monoxide threshold level and the slag height level returns to above a slag height threshold level. Alternatively, if the slag height is below a slag height threshold level and if the carbon monoxide is below a carbon monoxide threshold level, then not enough carbon is reacting with the oxygen (or vice versa) to achieve the desired carbon monoxide levels. As such, the carbon and/or oxygen can be added or increased and the carbon monoxide and slag height monitored to determine if the carbon monoxide level returns to above the carbon monoxide threshold level and the slag height level returns to above the slag height threshold level.

The embodiments described herein are discussed with respect to monitoring the CO levels in order to determine if enough or too much carbon or oxygen is being added to the EAF. In other embodiments of the invention instead of, or in addition to monitoring the CO level, the CO₂ level may be monitored to determine if enough or too much carbon or oxygen is being added to the EAF. In still other embodiments of the invention instead of, or in addition to monitoring the CO and/or CO₂ level, values of the combination of these off-gases may be monitored, such as but not limited to the value of (CO₂/(CO+CO₂)). These values may be measured as a percentage of the off-gas exiting the furnace, or as a specific number identifying the amount of the gases exiting the furnace. As such, it should be understood that when utilizing any one of the terms CO, CO₂, or a CO—CO₂ value, anyone of these terms may be substituted for each other within this specification and the resulting discussion should work in the same or similar way. As such, use of the term “carbon indicator” may also be utilized to describe any one of these terms, or related terms not specifically discussed herein.

The slag height level measurement system and/or the off-gas analysis system may be used in other ways during the steelmaking process, such as to determine when the scrap steel has melted (e.g., turned completely molten or substantially molten with only chunks of scrap metal remaining within the molten metal). For example, in one embodiment as the scrap steel melts and becomes molten the carbon monoxide content in the off-gas and the slag height of the foamy slag continuously rise, and thereafter plateaus as the scrap steel has melted into a molten pool. Moreover, in addition to these measurements, the arc stability (e.g., a measurement related to electrical current and/or the noise of the EAF) may be monitored to determine when the scrap steel has melted or substantially melted (e.g. small chunks are located within the molten steel pool). In other embodiments of the invention the slag height level measurement system and/or the off-gas analysis system may be used for other purposes during the steelmaking process. For example, the off-gas analysis system may be utilized to determine an estimate for the carbon level in the molten steel near or at the end of the heat (e.g., after the steel has melted and the EAF is switched off). A heat is described a single use of the EAF from charging to melting to tapping (e.g., removal of the molten steel). In other embodiments, the off-gas analysis system may be utilized to measure the H₂ and/or H₂O content in the furnace in order to determine if there is water leak into the furnace and/or if there is potential for an explosive event (e.g., steam build up from too much H₂O, too much H₂ which could ignite, or the like).

Embodiments of the present invention comprise a method of manufacturing steel. The method includes monitoring a slag height level in the EAF using a slag height measurement system. Also, monitoring a carbon indicator level exiting the furnace in real-time or near-real time using an off-gas analysis system. Thereafter, determining to increase carbon or oxygen injected into the EAF when the slag height level is below a slag height threshold level and the carbon indicator level is below a carbon indicator threshold level to return the carbon indicator level to above the carbon indicator threshold level, and to return the slag height level to above the slag height threshold level. The method further includes determining to decrease the carbon or the oxygen injected into the EAF when the slag height level is below the slag height threshold level and the carbon indicator level is above the carbon indicator threshold level to maintain the carbon indicator level above the carbon indicator threshold level, and to return the slag height level to above the slag height threshold level.

In further accord with an embodiment of the invention, the slag height measurement system comprises one or more vibration sensors coupled to the EAF.

In another embodiment of the invention, the off-gas analysis system comprises an off-gas laser sensor located on an exit of the EAF or on an exhaust duct coupled to the exit of the EAF.

In still another embodiment of the invention, monitoring the carbon indicator level in real-time or near-real time comprises monitoring a carbon monoxide level, a carbon dioxide level, or a combined carbon monoxide and carbon dioxide level, and receiving the carbon monoxide level, carbon dioxide level, or combined carbon monoxide and carbon dioxide level measurements within 10 seconds.

In yet another embodiment of the invention, determining to increase the carbon or the oxygen injected into the EAF includes determining to increase the carbon injected into the EAF first and determining if the carbon indicator level returns to above the carbon indicator threshold level, and determining to increase the oxygen injected when injecting the carbon into the EAF does not return the carbon indicator level to above the carbon indicator threshold level.

In further accord with an embodiment of the invention, determining to decrease the carbon or the oxygen injected into the EAF includes determining to decrease the carbon injected into the EAF first and determining if the carbon indicator level remains above the carbon indicator threshold level, and determining to decrease the oxygen injected when decreasing the carbon injected into the EAF fails to maintain the carbon indicator level above the carbon indicator threshold level or does not return the slag height to above the slag height threshold level.

In another embodiment of the invention, the method further comprises determining when the scrap steel has substantially melted into a molten pool of metal by monitoring the carbon indicator level, the slag height level, and an arc stability measurement.

In still another embodiment of the invention, determining when the scrap steel has substantially melted into a molten pool of metal by monitoring the carbon indicator level, the slag height level, and an arc stability measurement includes determining when the carbon indicator level in the off-gas has plateaued, determining when the slag height level has plateaued, and determining when the arc stability measurement meets a desired arc stability measurement level.

In yet another embodiment of the invention, increasing the oxygen comprises increasing the flow of oxygen in a burner and decreasing the flow of natural gas to reduce the oxygen consumed by combustion of the natural gas resulting in an increase in the oxygen to the EAF, and decreasing the oxygen comprises decreasing the flow of the oxygen in the burner and increasing the flow of the natural gas to increase the oxygen consumed by combustion of the natural gas resulting in a decrease in the oxygen to the EAF.

In further accord with an embodiment of the invention, monitoring the slag height level and the carbon indicator level is used to adjust the carbon and the oxygen injection in real-time or near real time during the steelmaking process or to determine a pre-programmed profile for the carbon and the oxygen injection.

Another embodiment of the invention comprises a system for manufacturing steel, comprising a furnace, a slag height level measurement system operatively coupled to the furnace, wherein the slag height level measurement system is used to monitor a slag height level in the furnace, and an off-gas analysis system operatively coupled to the furnace, wherein the off-gas analysis system is used to monitor a carbon indicator level exiting the furnace in real-time or near-real time. The system is used to determine when the slag height level is below a slag height threshold level and the carbon indicator level is below a carbon indicator threshold level, and in response increasing the carbon or oxygen added to the furnace to return the carbon indicator level to above the carbon indicator threshold level, and to return the slag height level to above the slag height threshold level. The system is also used to determine when the slag height level is below the slag height threshold level and the carbon indicator level is above the carbon indicator threshold level, an in response decreasing the carbon or the oxygen added to the furnace to maintain the carbon indicator level above the carbon indicator threshold level, and to return the slag height level to above the slag height threshold level.

In further accord with an embodiment of the invention, the slag height level measurement system comprises one or more vibration sensors coupled to the furnace.

In another embodiment of the invention, the off-gas analysis system comprises an off-gas laser sensor located on an exit of the EAF or on an exhaust duct coupled to the exit of the EAF.

In still another embodiment of the invention, the system used for monitoring the carbon indicator level in real-time or near-real time comprises monitoring a carbon monoxide level, a carbon dioxide level, or a combined carbon monoxide and carbon dioxide level, and receiving the carbon monoxide level, carbon dioxide level, or combined carbon monoxide and carbon dioxide level measurements within 10 seconds.

In yet another embodiment, the system used for increasing the carbon or the oxygen injected into the furnace comprises determining to increase the carbon injected into the EAF first and determining if the carbon indicator level returns to above the carbon indicator threshold level, and determining to increase the oxygen injected when injecting the carbon into the EAF does not return the carbon indicator level to above the carbon indicator threshold level.

In further accord with an embodiment of the invention, the system used for decreasing the carbon or the oxygen injected into the furnace comprises determining to decrease the carbon injected into the EAF first and determining if the carbon indicator level remains above the carbon indicator threshold level, and determining to decrease the oxygen injected when decreasing the carbon injected into the EAF fails to maintain the carbon indicator level above the carbon indicator threshold level or does not return the slag height to above the slag height threshold level.

In another embodiment of the invention, the system further comprises an arc stability measurement system, and wherein the off-gas analysis system, the slag height measurement system, and the arc stability measurement system are used to determine when the scrap steel has substantially melted into a molten pool of metal bay monitoring the carbon indicator level, the slag height level, and an arc stability measurement.

In still another embodiment of the invention, the system used for determining when the scrap steel has substantially melted into the molten pool of metal comprises determining when the carbon indicator level in the off-gas has plateaued, determining when the slag height level has plateaued, and determining when the arc stability measurement meets a desired arc stability measurement level.

In yet another embodiment of the invention, the system used for increasing the oxygen comprises increasing the flow of oxygen in a burner and decreasing the flow of natural gas to reduce the oxygen consumed by combustion of the natural gas resulting in an increase in the oxygen to the EAF, and the system used for decreasing the oxygen comprises decreasing the flow of the oxygen in the burner and increasing the flow of the natural gas to increase the oxygen consumed by combustion of the natural gas resulting in a decrease in the oxygen to the EAF.

In further accord with an embodiment of the invention, the system used for monitoring the slag height level and the carbon indicator level is used to adjust the carbon and the oxygen injection in real-time or near real time during the steelmaking process or to determine a pre-programmed profile for the carbon and the oxygen injection.

Another embodiment of the invention comprises a method of manufacturing steel, comprising monitoring a slag height level in a furnace using a slag height measurement system, monitoring a carbon indictor level in the furnace in real-time or near-real time using an off-gas analysis system, and using the slag height level and the carbon indicator level to determine when the scrap steel has substantially melted into a molten pool of metal.

Another embodiment of the invention comprises a system for manufacturing steel, comprising a furnace, a slag height level measurement system operatively coupled to the furnace, wherein the slag height level measurement system is used to monitor a slag height level in the furnace, and an off-gas analysis system operatively coupled to the furnace, wherein the off-gas analysis system is used to monitor a carbon indicator level exiting the furnace in real-time or near-real time. The system uses the slag height level and the carbon indicator level are to determine when the scrap steel has substantially melted into a molten pool of metal.

To the accomplishment of the foregoing and the related ends, the one or more embodiments of the invention comprise the features hereinafter fully described and particularly pointed out in the claims. The following description and the annexed drawings set forth certain illustrative features of the one or more embodiments. These features are indicative, however, of but a few of the various ways in which the principles of various embodiments may be employed, and this description is intended to include all such embodiments and their equivalents.

### BRIEF DESCRIPTION OF THE SEVERAL VIEWS OF THE DRAWINGS

The foregoing and other advantages and features of the invention, and the manner in which the same are accomplished, will become more readily apparent upon consideration of the following detail description of the invention taken in conjunction with the accompanying drawings, which illustrate embodiments of the invention and which are not necessarily drawn to scale, wherein:

FIG. 1 illustrates a high level process flow for controlling a furnace, in accordance with an embodiment of the invention;

FIG. 2 illustrates a process flow for controlling an EAF during a steelmaking process, in accordance with an embodiment of the invention;

FIG. 3 illustrates a perspective view of an EAF with a slag height level measurement system and off-gas analysis system, in accordance with an embodiment of the invention;

FIG. 4 illustrates a top view of an EAF with a slag height level measurement system and off-gas analysis system, in accordance with an embodiment of the invention;

FIG. 5 illustrates a cross-sectional view of an EAF exhaust duct with an off-gas analysis system, in accordance with one embodiment of the invention;

FIG. 6 illustrates an output interface for a slag height level measurement system, in accordance with an embodiment of the invention;

FIG. 7 illustrates an output interface for an off-gas analysis system, in accordance with an embodiment of the invention; and

FIG. 8 illustrates an output interface for a slag height level measurement system and off-gas analysis system, in accordance with an embodiment of the invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to like elements throughout.

There are a number of costs associated with running an EAF, including but not limited to the cost of electricity for running the electrodes to melt the scrap steel, the cost of carbon injected into the EAF to promote slag foaming, the cost of natural gas injected into the EAF to heat solid scrap, maintain the molten steel along with the electrodes, or to facilitate the coherent oxygen injection (e.g., a tight delivery stream of oxygen and natural gas as opposed to a fanned out delivery stream), as well as the cost of oxygen injected into the EAF for facilitating chemical reactions and promoting slag foaming, among other costs. As described throughout this application the present invention provides systems and methods for determining the profile for running the EAF before the heat commences or during the process itself. In one embodiment the test data may be monitored (e.g., through the slag height measurement system and off-gas analysis system) over multiple heats in order to determine the most efficient EAF control profile for running the EAF based on the steel being produced. In other embodiments of the invention, the present invention may be utilized in real-time or near real-time to determine how to control the EAF. Regardless of how it used, the present invention may be utilized to determine when to turn on, turn off, reduce, or increase the power of the electrodes, when the burners should be turned on or off, and when carbon injection, oxygen injection, and natural gas injection can be increased, reduced, turned on, or turned off. The present invention may reduce the costs of manufacturing steel in a single EAF by millions of dollars over the course of a year, as discussed in further detail later.

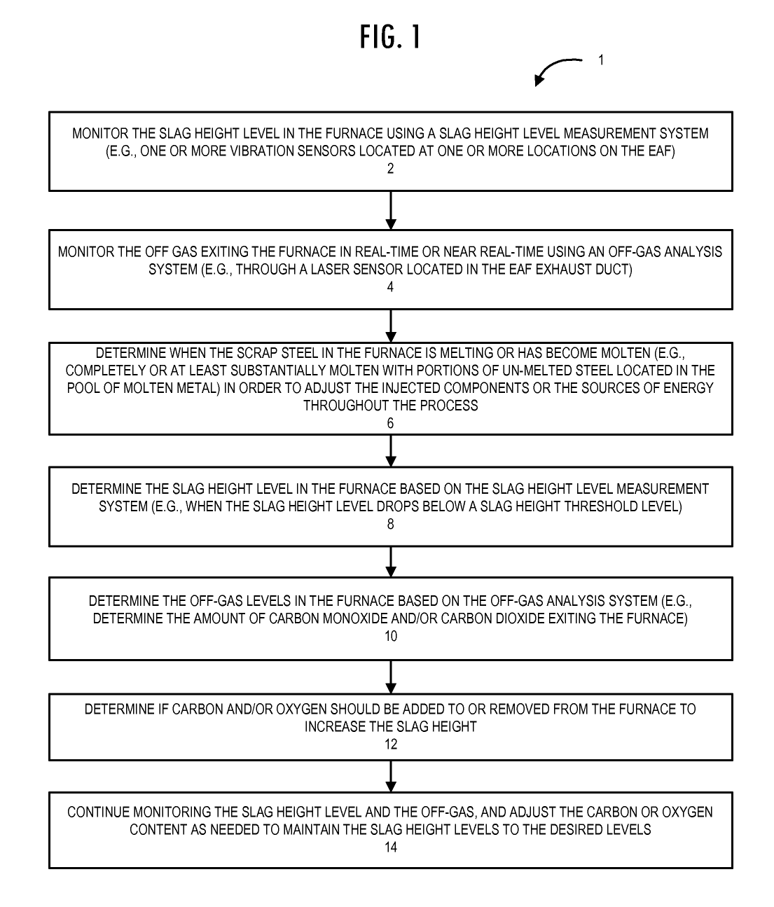

FIG. 1 illustrates a high-level process flow for controlling carbon and oxygen injection into a furnace 1, for example during a steelmaking process in an EAF. As illustrated by block 2 in FIG. 1, the slag height level in the EAF is monitored using a slag height level measurement system. Typically, the slag height level is determined by an EAF operator without a slag height level measurement system by listening to the noise made by an EAF during the steelmaking process. In response to a low slag height level the EAF operator may turn on the carbon injection system, which would inject a pre-programmed amount of carbon into the EAF, or manually inject an amount of carbon into the furnace. The problem with injecting carbon when the slag height level falls is that the low slag height level may not be a result of low carbon levels, as will be disused in further detail later. Relying on an EAF operator to determine a slag height based on the noise of the EAF is inconsistent and may lead to inefficiencies in running the EAF or in the molten metal created by the process (e.g., too much or too little carbon) because it is a subjective measurement that varies between different EAF operators. Instead of relying on simply the noise of the furnace as determined by an EAF operator, in the present invention a slag height measurement system may be utilized to determine the slag height in the furnace more accurately. In some embodiments, as discussed in further detail below, the slag height level measurement system may comprise the use of one or more vibration sensors located in or on one or more surfaces of the EAF to determine an average slag height within the EAF or a slag height within specific locations within the EAF.

Because the reason for a low slag height level within the EAF may be based on a number of different variables, such as un-melted scrap steel in the molten metal, the amount of carbon in the EAF, the oxygen and natural gas injection into the EAF, or the like, the present invention utilizes an off-gas analysis system to help determine the reasons for a low slag height level (e.g., below a slag height threshold level). As such, as illustrated by block 4 in FIG. 1 the off-gases may be monitored in real-time or near-real time using an off-gas analysis system, as will be explained in further detail later. The off-gas analysis system may determine, among other off-gas compositions and process parameters, the amount of carbon monoxide and/or carbon dioxide in the off-gas. The amount of carbon monoxide or carbon dioxide in the EAF may help determine when the scrap steel has melted, as well as when carbon and oxygen injection should begin, increase, decrease, and/or stop.

As illustrated by block 6, in some embodiments of the invention a determination is made when the scrap steel within the EAF is melting or has become melted throughout the steel making process. For example, determinations may be made as to when enough steel has melted in order to add additional charges of scrap steel, when the carbon, oxygen, and natural gas should be turned on, adjusted, or turned off during the process, and when the scrap steel is molten at the end of the process and the electrodes can be shut off. As such, in one embodiment as the scrap steel melts and becomes molten the carbon monoxide content (or the carbon dioxide content, or the like) in the off-gas may continuously rise and plateau as all or substantially all of the scrap steel becomes molten. Moreover, in some embodiments of the invention as the scrap steel melts and becomes molten the slag height within the EAF may rise and plateau as all or substantially all of the scrap steel becomes molten. In addition to the carbon monoxide and/or the slag height measurements, the arc stability may be used to determine when the scrap steel has melted. For example, when the arc is unstable at the beginning of the melting process a lot of noise is created and as more steel melts the furnace quiets and makes less noise. This volatility may be measured using the electrode current signal of the electrodes. For example, near the beginning of the process the electrode current may jump over the span of a second from 65,000 amps to 45,000 amps and back to 70,000 amps the next second. As the steel melts the variation in the current is reduced because the arc from the electrode is not jumping around within the EAF to different parts of the unmelted scrap steel. As such, as the volatilely is reduced (e.g., the standard deviation in the measurements is reduced) a determination may be made that the steel has melted. While alone these three measurements (e.g., carbon monoxide, carbon dioxide, carbon monoxide—carbon dioxide, or another like carbon indicator measurement, the slag height measurement, and/or the arc stability measurement) may or may not provide a satisfactory indication of when the scrap steel has melted, but together they may provide a better indication of when the scrap steel has melted. More accurately identifying when the scrap steel has become molten may allow the electrode power, carbon injection, oxygen injection, or natural gas injection to be altered at the desired time in order to maximize the electrical energy and inputs used during the steelmaking process.

At this point in the process, when the scrap steel beings to melt or has become at least partially molten, the slag height level measurement system may be activated or may begin to provide reliable slag height results if the system has already been activated (e.g., in some embodiments accurate slag height readings may not be made until the steel has melted or substantially melted). Depending on the amount of carbon included in the one or more charges of scrap steel, for example, in the scrap steel itself or in additional carbon sources added to the scrap steel charges, the slag height level may be above or below the desired slag height level as the steel becomes molten, or completely or substantially molten. During melting or after the steel has melted (e.g., throughout the steel making process), the carbon, oxygen, and natural gas may be injected into the furnace (or altered) as needed in order to maintain the slag height level and keep the molten steel at the desired temperatures. As such, the slag height level is also based on the amount of carbon and oxygen injected into the EAF during the steelmaking process and when the carbon and oxygen injection occur.

As illustrated by block 8 in FIG. 1, either when the scrap steel beings to melt, after the scrap steel has become molten, during other specific time periods during steelmaking, or throughout the steelmaking process, the slag height level measurements system provides a notification when the slag height level drops below a specified slag height threshold level. During steelmaking processes that utilize a slag height monitor, in response to the slag height dropping below a threshold level, carbon is injected to the EAF either manually or through the use of a feedback system that automatically injects the carbon when a drop in the desired slag height is identified. In some embodiments the amount of carbon injected may be a preprogrammed amount of carbon based on the desired composition of steel and the measured amount of the height of the slag. Unlike these steelmaking processes, in the present invention as illustrated by block 10, when the slag height level drops below a desired slag height threshold level, the off-gas analysis system is utilized to determine in real-time or near real-time if the carbon monoxide content is above or below a desired carbon monoxide threshold level. By determining the carbon monoxide level in real-time or near real-time as the slag height level drops below a threshold slag height level, a determination can be made immediately as to why the slag height level has dropped.

As illustrated by block 12 in FIG. 1, a determination is made as to if carbon and/or oxygen should be added or removed from the EAF to increase the slag height level back above a slag height threshold level. If the carbon monoxide level (or carbon dioxide level, value based on the combination of both, or the like) has remained above a threshold carbon monoxide level (or carbon dioxide threshold level, or combined value threshold level) when the slag height level has dropped below a slag height threshold level, then the desired amount of carbon is reacting with the desired amount of oxygen, and as such the slag is either carbon rich (e.g., thick) or oxygen rich (e.g., runny). If alternatively, the carbon monoxide level (or other carbon indicator measurement level) has dropped below a carbon monoxide threshold level (or other carbon indicator threshold level) when the slag height level has dropped below a slag height threshold level, then the desired amount of carbon is not reacting with the desired amount of oxygen, and as such the slag is either carbon deficient (e.g., runny) or oxygen deficient (e.g., thick). This determination could not be made using a slag height level measurement system alone, or an off-gas analysis system alone. Moreover, in order to react to the low slag height level by adding or removing carbon and/or oxygen, the analysis of the off-gas should occur in real-time or near real-time. Taking samples of the off-gas downstream of the EAF at cooler locations does not provide the desired turnaround time that allows for the adjustment of the carbon and/or oxygen injection (e.g., in real-time or near-time during the process, or through a more accurate pre-programmed profile) in order to return to the desired carbon monoxide levels and the desired slag height levels that result in improved EAF efficiency.

As illustrated by block 14, monitoring of the slag height level and off-gas analysis is continued using the slag height level measurement system and the off-gas analysis system, and adjustments to the carbon and oxygen levels continue throughout the steelmaking process to improve EAF efficiency. Moreover, these systems may be utilized to provide a more accurate determination of when the steel has become molten or substantially molten in order to turn of the electrodes and save costs associated with power consumption.

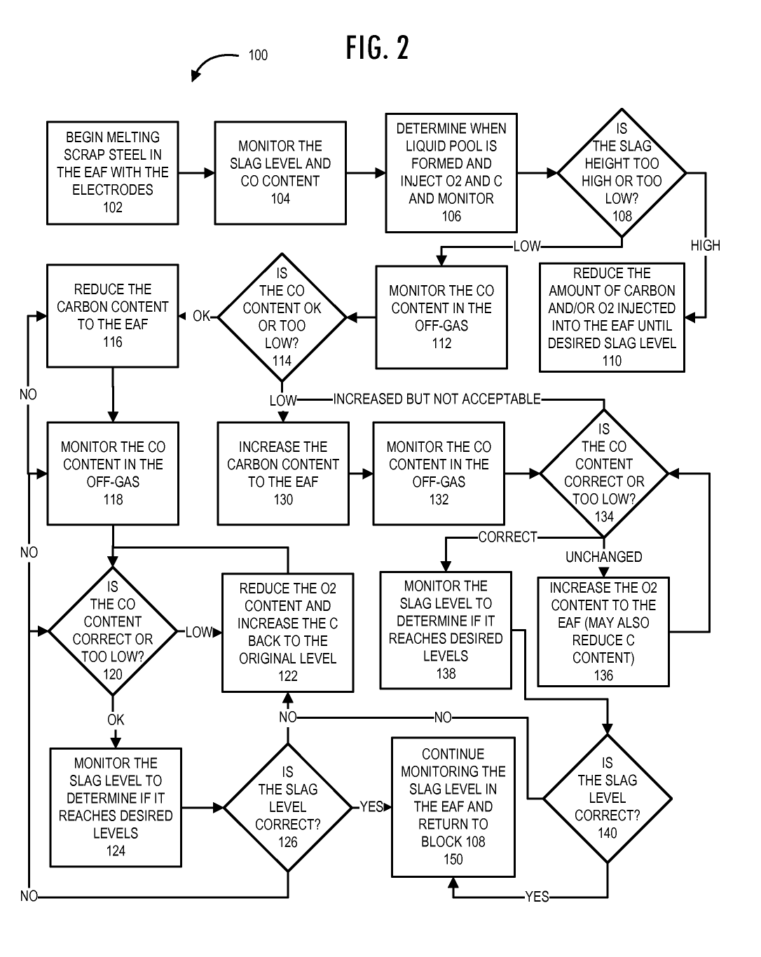

FIG. 2 illustrates a detailed process flow for controlling an EAF 310 during a steelmaking process 100. Moreover, Table 1 below illustrates in another form a general illustration of what occurs within the EAF 310 when the oxygen and carbon levels are too low, too high, or at the correct levels. FIG. 2 provides a method of determining when the situations illustrated in Table 1 occur and how the carbon and oxygen may be adjusted in one embodiment of the invention in order to achieve the desired carbon and oxygen content that results in the desired slag height level, and ultimately improved EAF efficiency.

TABLE 1
Carbon and Oxygen impact on slag height level and carbon monoxide level

| C vs. O content | O - high | O - correct | O - low |
|---|---|---|---|
| C - high | CO is high and slag will | CO level is correct | CO level is low because |
| | foam out of the EAF | because the O is correct, | O is low, and the slag |
| | | but the slag level is low | level is low and thick |
| | | and thick because of | because of excess C |
| | | excess C with respect to | with respect to O. |
| | | O. | |
| C - correct | CO level is correct | CO level is correct, and | CO level is low because |
| | because of the correct C, | the slag level is correct. | O is low, and the slag |
| | but the slag level is low | | level is low and thick |
| | and runny because of | | because of the excess C |
| | the excess O. | | with respect to O. |
| C - low | CO level is low because | CO level is low because | CO level is low, and the |
| | C is low, and the slag | C is low, and the slag | slag level is low because |
| | level is low and runny | level is low and runny | of low C and O, but slag |
| | because of the excess O | because of excess O | consistency is good |
| | with respect to C. | with respect to C. | (correct ratio of C/O). |

As illustrated by block 102 in FIG. 2 the process begins by charging an EAF with scrap steel. In some embodiments the charge of scrap steel will include a source of carbon (e.g., coal, coke, carbon powder, crumb rubber, carbon particles, or any other carbon based material) for promoting slag formation during the melting process. In some steelmaking facilities a single charge is made into the EAF. In other steelmaking facilities a first charge is made into the EAF, melting of the scrap steel begins using one or more electrodes, and one or more additional charges are made into the EAF as needed to fill the EAF.

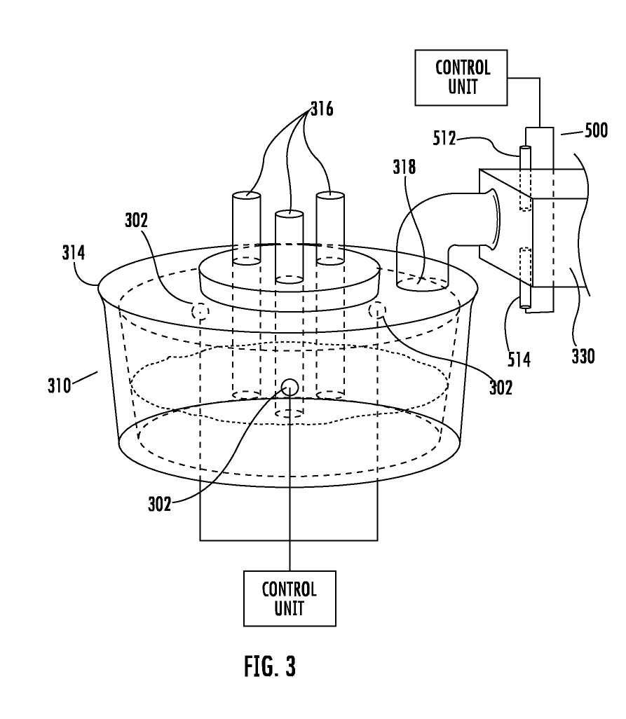

As illustrated by block 104 in FIG. 2, the slag height level is monitored using the slag height level measurement system and the carbon monoxide content is measured using the off-gas analysis system. One embodiment of a slag height level measurement system and an off-gas analysis system is illustrated in FIGS. 3 through 5.

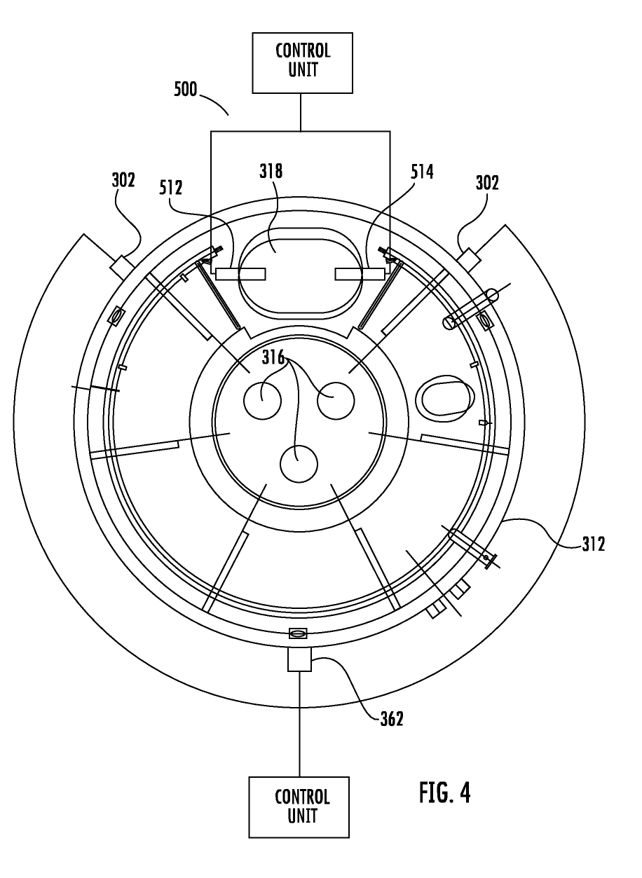

As illustrated by FIGS. 3 and 4, in some embodiments of the invention the slag height level measurement system is a vibration sensor system 300 that utilizes one or more vibration sensors 302 which are operatively coupled to the EAF 310 in order to measure the vibrations in the EAF 310 and approximate the slag height level based on the vibrations. In one embodiment of the vibration sensor system 300, one or more vibration sensors 302 are coupled to the EAF wall 312, lid 314, electrodes 316, or other locations of the EAF 310, and are used to measure the vibrations of the EAF 310 or the components associated with the EAF 310. The sensors 302 are monitored using software (e.g., computer program products, or the like), which receive the vibration data and equate the vibrations to a level of slag height in the EAF 310. In response to the determination of the slag height level, an EAF operator may manually inject carbon into the EAF 310, or the vibration system may automatically inject carbon into the EAF 310.

In one specific embodiment, the Seimens SonArc Foamy Slag Manager (FSM) System is used, which has three vibration sensors 302 that are located around the circumference of the EAF 310. In some embodiments the vibration sensors 302 are placed in the cavity between the inner wall (e.g., hot wall) and the outer wall (e.g., cold wall) of the upper shell of the EAF 310. For example, when three electrodes 316 are used, three vibration sensors 302 are located on the wall 312 of the EAF 310 approximately across from each of the electrodes 316 (more or less sensors 302 may be used based in part on the number of electrodes). After an arc is created between the electrodes 316 and the metal scrap steel, noise is generated by the arcs as vibrations created by the arcs radiate against the EAF 310 walls 312. As the scrap steel and any sources of carbon located in the initial charge of scrap steel begin to melt and burn, a slag is formed on top of the molten pool of metal. The slag foams and covers the electrode arcs, electrodes 316, inside walls 312, and inner roof 314 of the EAF 310, which dampens the noise and vibrations of the EAF 310. As the scrap steel melts, the vibration sensors 302 are used to measure the noise in the EAF 310 in order to determine the slag height level through the air-borne and structure-borne sound coming from inside the EAF 310. The readings of the vibration sensors 302, and the determination of the slag height based on the readings, may increase in accuracy as the steel becomes molten or is substantially molten. A feedback system may be associated with the vibration sensors 302, which may automatically inject an amount of carbon into the furnace when the slag height level measured using the vibration sensor system 300 drops below a slag height threshold level, falls outside a range of slag height threshold levels, or the like. For example, when the noise in the EAF 310 is low, a good foaming slag has formed and carbon injection into the EAF 310 is not needed or does not need to be further adjusted. However, when the noise and the vibrations in the EAF 310 increase, the slag height level has dropped and in response carbon is injected into the EAF 310 or the carbon being injected into the EAF 310 is increased, either manually or automatically. One issue with the manual or automatic injection of carbon into the EAF 10 when the slag height level falls below a slag height threshold level is that low carbon levels may not cause the low slag height level.

In order to determine why the slag height level has fallen, the present invention utilizes an off-gas analysis system that can measure the off-gas exiting the furnace in real time or near real-time, which is illustrated in one embodiment in FIGS. 3 through 5. Off-gas analysis may occur within an EAF 310 through the use of thermocouples, infrared, gas sampling, or other sensors located downstream in an exhaust duct or baghouse. However, due to the high temperatures near an EAF 310 these sensors are located far away from the EAF 310, such that by the time the off-gas is analyzed it may have been a number of seconds (e.g., 30 or more) or minutes since the off-gas has left the EAF 310. As such, using systems, such as gas sampling downstream of the EAF 310, does not provide the instant feedback of the present invention. In these types of systems it may be a 30 second delay or more before the composition of the off-gas exiting the EAF 310 may be determined. In some embodiments even if these systems could be placed near the EAF off-gas exit 318 or entrance to the exhaust duct 330 these systems may still require a response time of 9 or 10 seconds or more, to determine the off-gas components, and moreover these systems may not be accurate.

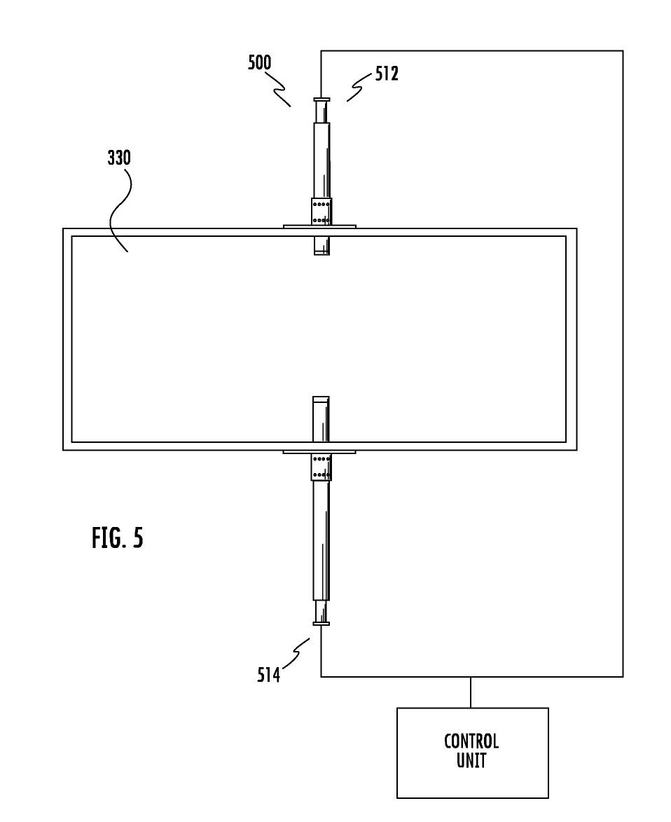

As such, in the present invention an off-gas laser measurement system 500, or other like system, may be utilized to analyze the off-gas near the exit of the gas from the EAF 310. For example, the off-gas analysis system may be located at the off-gas exit 318 in the lid 314 of the EAF 310, as illustrated by FIG. 4. Alternatively, as illustrated in FIGS. 3 and 5 the off-gas analysis system may be located in the exhaust duct 330 of the EAF 310 at a location adjacent to the EAF 310 and or off-gas exit 318. As such, the present invention may be able to identify the off-gas components in 1 to 3 seconds, 1 to 5 seconds, 1-8 seconds, or the like (e.g., in less than one second, such as 0.1 seconds to 3, 5, or 8 seconds, or the like). In other embodiments the response time may be within these ranges, outside of these ranges, or overlap these ranges.

In one embodiment, an off-gas laser system 500 used to analyze the off-gases may be the ZoloBOSS system. For example, in one embodiment laser probes 510 are located in the ductwork 330 near the off-gas exit 318 (e.g., the 4^{th} hole in the lid 314) in the EAF 310, as illustrated in FIGS. 3 and 5. In other examples, laser probes 510 are located adjacent the off-gas exit 318 in the EAF lid 314, as illustrated in FIG. 4. In some embodiments, a laser emitter 512 is located in one probe and a laser receiver 514 is located in a second probe. The laser emitter 512 emits frequencies (e.g., different frequencies of laser light in different beams that are combined in a single laser) of light and each of the gases passing by the laser influence the frequencies received by the laser receiver 514. The signals received are analyzed (e.g., received and decoupled into the separate frequencies) to determine the characteristic signatures for each of the gases in order to identify the amount of each in the off-gas. In the present invention, an analysis of the off-gas may be used to determine why the slag height level has fallen. Determining the off-gas accurately in real time or near real-time in the present invention allows the EAF 310 to be controlled more efficiently. As such, being able to achieve an accurate measurement of the off-gas within 1 to 3, 1-5, or 1-8, or other ranges within, overlapping, or outside of these ranges may allow the operators to run the EAF 310 more efficiently in real time or based on pre-programmed profiles.

As illustrated by block 106 in FIG. 2, a determination is made when a liquid pool of molten metal is formed from the melting the scrap steel. As the scrap steel is being melted the carbon monoxide generally increases indicating that the scrap steel is melting. As the carbon monoxide plateaus (or other carbon indicator) this provides an indication that the scrap steel has become molten. As previously discussed, additional indications of when the scrap steel (e.g., single charges or the combination of the one or more charges) has become molten may be when the increasing slag height (e.g., as measured by the slag height level measurement system) stops increasing and plateaus. Moreover, an arc stability measurement based on the currents that supply power to the electrodes 316 may also indicate that the scrap steel has melted when the variation in the current is less than a specified standard deviation (e.g., two standard deviations, one standard deviation, or the like). One of these measurements or the combination of two or more of these measurements may indicate when the steel has become molten.

Decision block 108 of FIG. 2 illustrates that a determination is made as to if the slag height is too high or too low, using the slag height level measurement system. As illustrated by block 110 if the slag height is too high, slag may foam out of the EAF and the determination of the slag height level using the slag height level management system may not be needed. If the slag height level is too high or foaming outside of the EAF then the amount of carbon and oxygen being injected into the EAF is reduced until the slag level returns to a desired range.

Returning to decision block 108 if the slag height measurement system determines that the slag height level has fallen below a threshold level, or in some embodiments, falls below a threshold range, then the carbon monoxide level (or other carbon indicator) is determined using the off-gas analysis system, as illustrated by block 112. In practice both of these systems (e.g., the slag height measurement system and the off-gas analysis system) may or may not be running continuously, and as such, slag height measurements and/or off-gas analysis measurements may or may not occur continuously. FIG. 2 and the associated specification related to FIG. 2 is described as monitoring the carbon monoxide in the off-gas; however, it should be understood that in addition to, or as an alternative to monitoring the carbon monoxide level in the off-gas, the off-gas analysis system may monitor the carbon dioxide level, a value that represents both and thereafter use one or more of a combination of these values to control the EAF 310. In other embodiments another carbon indicator may be analyzed by the off-gas analysis system to control the EAF 310. As such, when describing that the carbon monoxide is monitored, it should be understood that the other off-gas components (e.g., carbon dioxide, a value of both CO and CO₂, or another carbon indicator) may be substituted for the term carbon monoxide (or monitored along with) and the present invention will still operate as described herein.

As illustrated by decision block 114, a determination is made as to if the carbon monoxide is within a particular range, or has fallen below a carbon monoxide threshold level or below a carbon monoxide threshold range. As such, if the carbon monoxide content is within appropriate levels this indicates that the EAF 310 is actually receiving enough carbon and oxygen, but the slag height level has fallen because there is too much carbon or oxygen. In the case where there is too much carbon the slag would be carbon rich, and thus the slag would be too thick and would not foam to the desired slag height level.

As illustrated in block 116, the level of carbon may first be reduced in order to determine if the EAF 310 is receiving too much carbon. In some embodiments, depending on how the carbon and oxygen is injected it may be easier to adjust the carbon as opposed to the oxygen. As such, the carbon is adjusted first in the illustrated embodiment in FIG. 2, but in other embodiments oxygen could be adjusted first, in the same way as will be described in further detail below. The carbon may be manually or automatically adjusted by reducing the carbon injection in real-time or near-real time by a specified amount based on the carbon monoxide level measured, based on another off-gas measurement, based on an estimated amount of carbon that will grow the measured slag height level, or based on another like factor.

After the carbon injection amount is reduced, the level of carbon monoxide may be monitored to determine if the reduction in the carbon level had an impact on the carbon monoxide content in the off-gas, as illustrated by block 118. Since the off-gas analysis measurement is received in real-time or near real-time at the exit 318 from the EAF 310 or in the exhaust duct 330 near the exit 318, a change in the carbon monoxide level may be detected within 1-5 seconds (or other time period discussed herein) after reducing the carbon injection into the EAF 310. In other embodiments the detection of the carbon monoxide may be outside of the this range or overlap this range, such as 1 to 10 seconds, 1 to 30 seconds, or the like.

As illustrated by decision block 120 if the carbon monoxide level has not changed (e.g., within 5, 10, 15, 20, 30, or the like seconds), this may be an indication that the carbon level in the furnace was too rich and reducing the carbon level was the correct action. As illustrated by block 124, the slag height level may be monitored to determine if it has returned to above a slag height level threshold or within a slag height level range. It may or may not take longer for the slag height level to react to the reduced carbon injection then it takes for the off-gas to change, and as such it may be 1, 3, 5, 8, 10, 12 or 15 seconds to 3, 5, 8, 10, 12, 15, 30 seconds, 1, 2, or 3 minutes before the slag height returns to above a slag height threshold level or within a slag height threshold range. In other embodiments of the invention the amount of time for the slag height measurement system to identify a change in the slag height level after changing the carbon (or oxygen) may fall within these ranges, overlap these ranges, or be located outside of these ranges.

As illustrated by decision block 126, a determination is made as to whether or not the slag height level has returned to above the desired slag height threshold level or within a desired slag height threshold level range. As illustrated by block 150 if the slag height level has returned to the desired level or range, then the process returns to decision block 108 to continue monitoring the slag height level in the EAF 310 throughout the rest of the steelmaking process or during specific time periods within the steelmaking process.

Returning to decision block 126, if the slag height level does not return to the desired levels after reducing the carbon injection, then the carbon injection may need to be reduced further or the oxygen injected into the furnace may also need to be reduced. As illustrated, the process may return to blocks, 116-126, to further reduce the carbon injection until the slag height level returns to the desire levels.

Returning to decision block 120, if at any point in time the carbon is being reduced, and the slag level does not return to above the slag height level threshold or threshold range, then instead of being carbon rich, the slag in the EAF 310 may be oxygen rich, which causes runny slag. In some embodiments, excess oxygen may occur within an EAF 310 when the scrap steel used to create the molten metal has large amounts of rust, or other iron oxides, which release oxygen into the EAF 310 as the rust and other iron oxides melt. As such, if the carbon monoxide level falls after reducing the carbon injected into the furnace this is an indication that the carbon injection level before the reduction of carbon was the correct amount of carbon for the EAF 310. Therefore, as illustrated by block 122 instead of further reducing the carbon, the oxygen injected into the EAF 310 may be reduced. In addition, in some embodiments the carbon injected into the EAF 310 may be increased to the level of carbon injected before the drop in the carbon monoxide level was determined. After reducing the oxygen level the process returns to blocks 120 to 126 until the oxygen is reduced to a point where the slag height level returns to above the desired slag height level threshold or threshold range.

Returning to block 114 in FIG. 2, in the case when the slag height level has fallen below a threshold level or threshold level range, and the carbon monoxide content is below the desired carbon threshold level or threshold range, the slag may be carbon deficient and/or oxygen deficient. As such, the amount of carbon or oxygen injected into the furnace may be increased.

As illustrated by block 130 in FIG. 2, in some embodiments of the invention the carbon may be adjusted first by increasing the amount of carbon injected into the furnace. Typically, when the slag height level has dropped below a threshold level or threshold range, it is due to low carbon and not low oxygen, but not always. As such, the carbon injection may be increased before increasing the oxygen injection into the EAF 310. However, in other embodiments the oxygen may be increased first or at the same or similar time as the adjustment in the carbon injection.

As illustrated by block 132, after the carbon is increased, the carbon content of the EAF 310 is measured using the off-gas analysis system. As illustrated by decision block 134 a determination is made as to if the carbon monoxide in the EAF 310 is unchanged, increased but still too low, or if it has returned to above the desired carbon monoxide threshold level or threshold level range.

If the carbon monoxide content increases, but does not return to the desired carbon monoxide threshold level or threshold range, then this is an indication that the carbon content is still deficient. As illustrated by blocks 130 to 134, additional carbon may be injected into the EAF 310, and the carbon monoxide content continues to be monitored.

If the carbon monoxide content returns to the desired threshold level or threshold range, then the slag height level is monitored to determine if it returns to the desired threshold levels, as illustrated by block 138. As illustrated by decision block 140 a determination is made as to if the slag height level has returned to the desired slag height threshold level or threshold range. As previously discussed, it may take longer to see a reaction in the slag height level than the carbon monoxide level. As illustrated by block 150, if the slag height level has returned to above a threshold level or within a threshold range then the process returns to block 108 and the slag height measurement system continues to monitor the slag height level throughout the rest of the steelmaking process or during at least a portion of the steelmaking process.

Returning to decision block 140, if the slag height level has not returned to above the slag height level threshold or threshold range when the carbon monoxide level has returned to the desired carbon monoxide threshold level, then the EAF 310 may in fact be oxygen rich. As illustrated by block 122, the amount of oxygen injected into the EAF 310 may be reduced and monitoring of the carbon monoxide and slag height levels are continued until the slag height levels return to the desired slag height threshold level or threshold level range.

Alternatively, returning to decision block 134, if the carbon monoxide content in the off-gas does not rise after increasing the carbon injection (e.g., is unchanged), then the slag may be oxygen deficient. As such, as illustrated by block 136, the amount of oxygen injected into the EAF 310 may be increased. In some embodiments the carbon content may also be reduced to the levels used before the increase to the carbon injection in block 130, if necessary. Block 134 of FIG. 2 further illustrates that after the increase in the oxygen the carbon monoxide content is monitored in order to determine if the carbon monoxide content has returned to above the carbon monoxide threshold level or threshold range. When the carbon monoxide level and the slag height level return to above the threshold levels, as illustrated by blocks 138, 140, and 150, then the process returns to block 108 and the slag height measurement system continues to monitor the slag height level throughout the rest of the steelmaking process.

In some embodiments, the slag height level, and off-gas analysis may be monitored manually through an EAF controller that monitors the EAF 310 while it is running. In other embodiments of the invention, one or more of the systems may be automatically coupled to a control unit, which automatically monitors the slag height level and the off-gas analysis, specifically the carbon monoxide levels, and in response increases or decreases the carbon and oxygen injection into the EAF as previously described with respect to FIGS. 1 and 2.

In still other embodiments of the invention measurements from a slag height measurement system and the off-gas analysis system may be analyzed after one or more EAF heats; and in response a pre-determined carbon and oxygen injection profile may be programmed for additional heats. As such, in some embodiments of the invention analyzing the slag height measurements and/or off-gas analysis measurements may indicate clues as to if the carbon and oxygen are being injected at the right time, and if the proper amounts of carbon and oxygen are being injected into the EAF 310. As such, the present invention may be used to optimize pre-programmed profiles for injecting the carbon and oxygen, and the amounts thereof, for particular types of steel compositions.

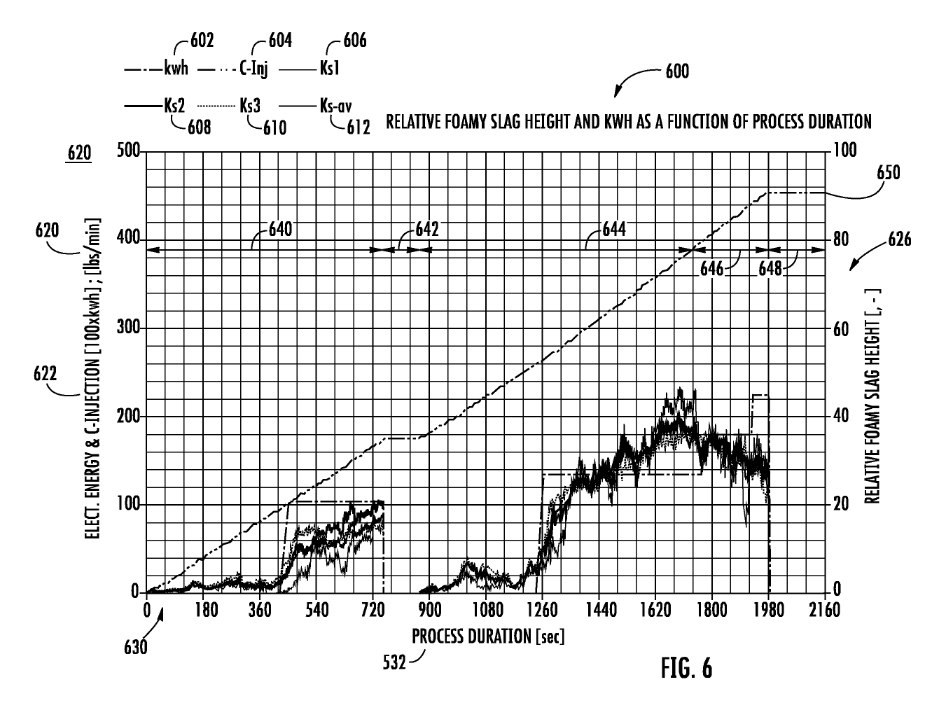

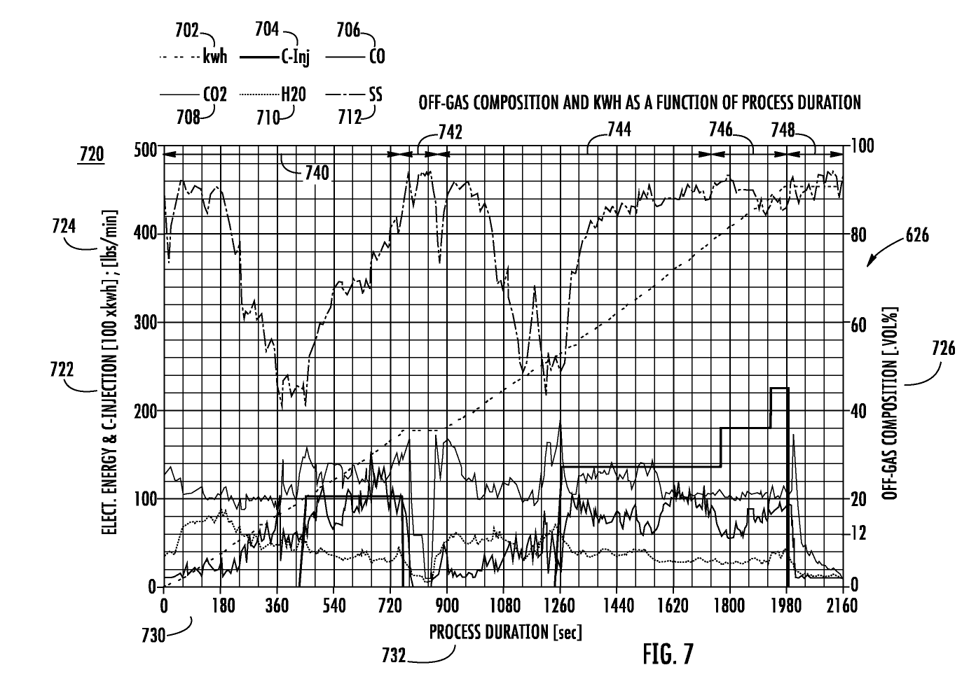

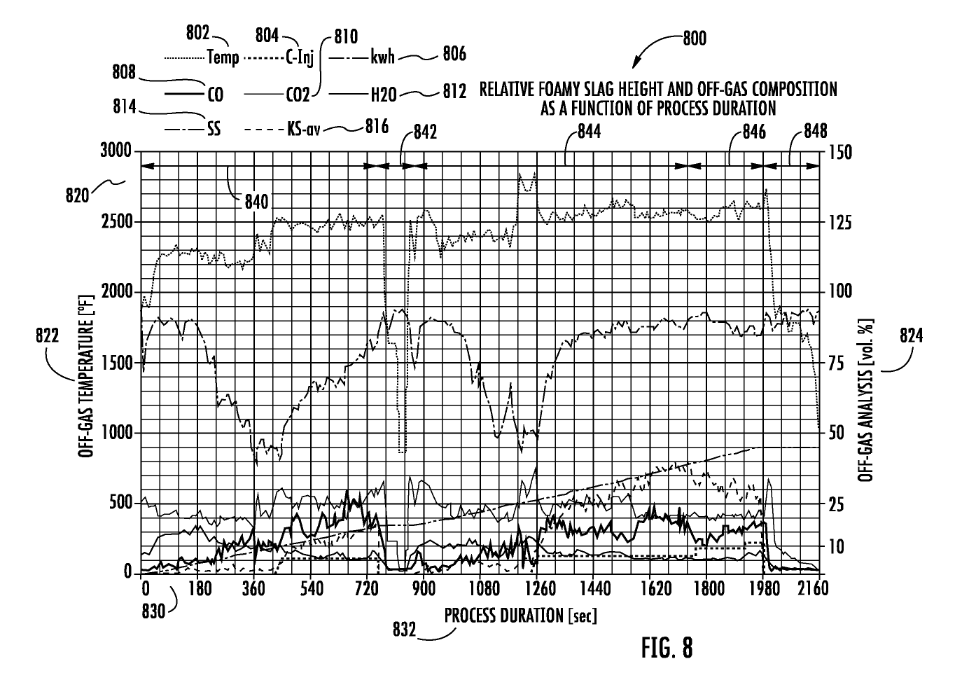

In one embodiment of the invention the output of the slag level measurement system and the off-gas analysis system may be displayed in one or more graphical interfaces in order to visually illustrate the measurements associated with these systems. For example, FIG. 6 illustrates a slag height level measurement system output interface 600, FIG. 7 illustrates an off-gas analysis system output interface 700, and FIG. 8 illustrates overlay interface 800 of the slag height level measurement system output interface 600 and the off-gas analysis system output interface 700. These interfaces are illustrated for a particular heat the EAF 310; however, these interfaces can be provided for any heat within an EAF 310 in real-time, near real-time, or after the heat is finished.

The heat illustrated in FIGS. 6-8, has the following process steps. After the initial charge is supplied to the EAF 310 the roof is swung in place and the electrodes 316 are lowered into the EAF 310. The initial charge may include scrap steel, carbon, and flux (e.g., dolomitic lime, or the like). The electrodes 316 are turned on, and the electrodes begin to arc with the steel, as illustrated at the time duration of 0 seconds in FIGS. 6-8. The steel will melt and the carbon will be consumed until enough of the scrap steel has melted in order to add a second charge to the EAF 310, as illustrated between 0 and approximately 750 seconds (i.e., 0 to 12.5 mins). In some types of EAFs 310 only a single charge may be placed into the EAF 310, but in other embodiments more than two charges may occur, or the EAF 310 may be constantly feed during the initial charging stage using a conveyer or another like device. During the initial melting stage oxygen, natural gas, and carbon may be blown into the EAF 310 based on pre-set injection profiles, or based on the conditions occurring during the initial melting using the slag height management system or the off-gas analysis system. However, as previously discussed these systems (e.g., specifically the slag height measurement system) may not provide the most accurate results until an appropriate amount scrap steel has become molten. As illustrated in the present invention carbon injection may occur around 420 second (7 mins). In addition, in some embodiments oxygen and natural gas may be injected from the start of the heat with the oxygen injection gradually increasing as the natural gas injection may decrease over this time period.

As illustrated in FIGS. 6-8, at approximately 750 seconds into the process (e.g., 12.5 mins) the oxygen, natural gas, and carbon injection may be turned off to add an additional charge to the EAF 310 after enough of the initial scrap steel has melted. During this point in the process the electrodes 316 are raised, the roof is swung to the side, and the second charge (e.g., scrap only, or scrap, carbon, and/or flux) is added to the EAF 310. The roof is swung back in and the electrodes 316 are lowered back into the EAF 310 and arching starts again at approximately 870 seconds (14.5 mins) in a second melting process. As is the case for the initial melting step, oxygen, natural gas, and carbon may be injected into the EAF 310 on an as needed basis or based on pre-set profiles. As illustrated in the present invention, carbon injection may occur around 1230 seconds (20.5 mins). In addition, in some embodiments oxygen and natural gas may be injected from the start of the second melting process with the oxygen injection gradually increasing as the natural gas injection may decrease over this time period. In addition, flux and other elements may be added to the EAF 310 in various amounts depending on the type of steel being produced.

The process continues until all of the scrap steel has melted. As illustrated by FIG. 6, the slag height measurement system indicates that the scrap steel has melted or substantially melted at approximately 1740 seconds (e.g., approximately 29 mins), as the slag height plateaus at approximately this time in the process. Moreover, FIG. 7 illustrates that around the same time that the slag height plateaus and begins to fall, the CO and CO₂ also plateaus at around 1720 seconds (e.g., approximately 29 mins), and thus this also indicates that all, or substantially all of the scrap steel has melted. Note that these melting times described herein may be different than the recited times based on the size of the furnace, the amount of scrap steel charged into the furnace, and/or other factors. As illustrated in FIGS. 6-8, at this point when the scrap steel has melted the steelmaking process should continue for a couple of minutes to make sure any chunks in the molten metal has melted and that temperature of the molten metal surpasses the liquidus temperature (e.g., temperature at which all of the solid material has become liquid) by a couple hundred degrees F. (e.g., more or less than approximately 200 degrees F. past the liquidus temperature). After the EAF is tapped the molten metal is transferred to a ladle and delivered to the metallurgy station so the temperature is required to be at a level before tapping such that the liquid metal will not solidify during tapping or transporting to metallurgy station. When it is determined that the scrap steel has melted, or substantially melted, at this point in time a large amount (e.g., all) of the energy from the electrodes and a large amount (e.g., all) of the oxygen may be required in order to reach the desired temperature of the molten metal before tapping. Additionally, carbon may be injected into the EAF 310 and the end of the process in order to achieve the desired carbon level in the steel. It is important at this stage at the end of the process to inject the right amounts of oxygen and carbon to achieve the desired levels of carbon in the molten steel.

At the end of the process it may be important to increase the oxygen and temperature right after melting is complete and then back off both before turning off the electrodes to reach the desired temperatures and oxygen composition at the desired time. It may also be important to avoid reaching a super heat situation during which the temperatures are too high and too much oxygen is injected into the EAF (e.g., oxygen may also act as an energy an increase the temperature of the molten metal or may pull too much carbon out of the molten metal). Ideally, you may want to pour the steel out at 3030 degrees F. (e.g., in a range of 3000 degrees F. to 3100 degree F.) and 900 ppm of oxygen (e.g., ranges from 700 to 1000 ppm, 850 to 950 ppm, or the like). At this point in time the carbon level in the molten steel may be approximately 0.04 wt. % C (e.g., range from 0.02 to 0.6 wt. % depending on the type of steel). Moreover, the metallurgical station will take the oxygen out of the steel down to about less than 5 ppm so sulfur can be removed from the steel. If too much O₂ is in the molten steel then it takes longer to remove the oxygen and it takes more material (e.g., Al) to reduce the oxygen, which increases the cost. In other embodiments of this invention, these values may change based on the type of steel being made.

As such, in order to reduce the electrical energy, oxygen, carbon, natural gas, or the like in order to reduce the costs associated with a single heat, it may be important to accurately identify when the scrap steel has become molten or substantially molten (e.g., with just some scrap steel still floating in the molten metal). The longer the process runs after the steel has melted the less efficient the EAF heat is and the more costly the heat becomes. Moreover, when the scrap steel has melted or substantially melted the efficiency of the electrodes 316 may be reduced because the arcs are not as efficient in arcing with the molten metal as they were with the scrap steel. As such, energy may be wasted when the use of the electrodes 316 is not adjusted as close as possible after the steel has become molten. As such the use of the electrodes 316 (and in some embodiments the natural gas burners) may be adjusted when it is determined that the scrap steel has become molten. As such, the total energy from the electrodes 316 may be reduced for the process in order to reduce the amount of electrical energy used when compared to how the electrodes 316 have been used in traditional processes. In addition, the natural gas and oxygen injection may be adjusted directly after melting (e.g., increased, reduced, turned off) in order to more effectively determine the oxygen injection into the EAF at the end of the process.

Not only does the present invention improve the EAF efficiency during the process by determining when and why the slag height may be too low, but the present invention may be utilized to decrease the processing time by more effectively determining when the steel has become molten, and thus, reduce the electrical energy used by the electrodes 316 and reduce the use of injected materials, by completing the process within the EAF 310 quicker in order to turn off the electrodes 316 and material injection sooner during the process.

Utilizing the slag height measurement system, the off-gas analysis system, and/or the electrode current signal to determine when the scrap steel is molten or is substantially molten allows for a better determination when the operator (manually or automatically) should adjust (e.g., increase then reduce or back-off) the electrode power and the oxygen injection after melting to improve or maximize efficiency of the EAF 310. The combination of these systems may be utilized to better determine when the steel is molten, and to come to a more efficient stop at the end of the steel manufacturing process without overshooting the end of the process, and consuming unnecessary energy (e.g., using the electrode energy longer than necessary) or material (e.g., carbon, oxygen, natural gas, or the like).

As such, in one embodiment tap to tap times (e.g., time from tapping a first heat to tapping a subsequent heat) may be approximately 45 minutes during typical steelmaking processes. The time during which the electrodes are on within a single heat of a typical steelmaking process may be an average of approximately 34 minutes (e.g., approximately 2040 seconds) depending on the type of EAF and the amount of steel being used. Utilizing the present invention may allow for the reduction of the average time during which the electrodes are on to less than approximately 34 minutes. In some embodiments the average time running the electrodes during a heat may be further reduced to less than 33.5, 33, 32.5, 32, 31.5, 31, 30.5, 30, or less minutes. The average time may be within, outside of, or overlap these ranges. As such, the reduction in the time at which electrodes are turned on may be reduced by 20, 15, 14, 13, 12, 11, 10, 9, 8, 7, 6, 5, 4, 3, 2, or 1 percent. The reduction in the amount of time that the electrodes are on may range within these values, overlap these values, or fall outside of these values.

As further illustrated in FIGS. 6-8, in one embodiment at approximately 1980 seconds (33 mins) the electrodes, the natural gas injection, the oxygen injection, and the carbon injection are suspended and turned off. The slag door is opened and the slag is removed from the EAF 310. Multiple measurements of the molten steel are made to determine the temperature, carbon, and oxygen content of the molten steel to determine if molten steel in the EAF 310 is ready for tapping. If the temperature is too cold, the electrodes and/or natural gas injection may be resumed in order to increase the temperature. If the carbon is too high oxygen may be injected in order to remove some of the carbon from the steel. If the carbon is to low, some carbon may be injected to increase the carbon level, or a determination of the amount of carbon injection needed in the ladle is made. Dependent on the type of steel being produced the carbon level within the steel may need to be less than 0.04% or up to 0.35% (in other embodiments the desired carbon level may be within, outside, or overlapping this range). Generally, the more oxygen that is injected into the EAF 310 during the steelmaking process the less carbon is in the steel. Depending on these measurements, a combination of these steps may be required or may not be needed to achieve the desired properties of the molten steel before tapping.

In some embodiments of the invention multiple samples of the temperature, oxygen, and carbon, such as 3, 4, 5, and 6 samples may be taken in order to determine the correct properties before tapping of the molten metal. After it is determined that the molten steel meets the desired properties, the EAF 310 is tapped and the molten metal is poured into a ladle. These multiple measurements take time and in some embodiments increase the amount of time it takes to begin the next heat. Moreover, turning on the electrodes and adding additional carbon or oxygen increases the costs associated with the heat. As such, the off-gas analysis system may be used to better control the amount of carbon and oxygen injection, and the temperature, at the end of the heat in order to reduce the adjustments that may have to be made after the electrodes and oxygen, carbon, and natural gas have been turned off. In some embodiments the amount of carbon in the melted steel may be estimated based on the amount of carbon injected and the CO and CO₂ levels monitored during the steelmaking process. Moreover, the temperature measurements from the off-gas analysis system may play a role in determining the temperature of the molten steel after the electrodes and oxygen, carbon, and natural gas have been turned off. As such, the off-gas analysis system may be able to eliminate or reduce the number of measurements performed on the molten steel before tapping.

FIGS. 6-8 illustrate interface outputs for one example heat, which are discussed in further detail below. FIG. 6 illustrates the slag height level measurement system output interface 600 in one embodiment of the invention. As illustrated, the interface may include the total energy 602 used throughout the heat of the EAF 310 using the electrodes. The interface 600 may also illustrate the amount of carbon injection 604, the slag height at a first sensor 606, the slag height at a second sensor 608, the slag height at a third sensor 610, and the average slag height 612. In other embodiments more or less slag height sensors may be used and outputs for each sensor may be displayed in the interface 600. Moreover, the interface 600 has a y-axis 620 that illustrates the amount of electric energy (kwh*100), the amount of carbon injected (lbs/min), and the relative slag height level (measured as a normalized value for example between 0-100). The illustrated slag height measurement system output interface 600 indicates that in the illustrated heat, as the carbon is injected the slag height rises. The interface has an x-axis 630 that illustrates the values on the y-axis as a function of processing time 632. The processing time may be divided up into stages within the steelmaking process, such as a first melting 640, a second charge of scrap steel 642, a second melting 644, preliminary refining 646, measurements 648, and tapping 650.

FIG. 7 illustrates an off-gas analysis system output interface 700. As illustrated, the interface 700 may provide the total energy 702 used throughout the single heat of the EAF 310. The interface may also illustrate the amount of carbon injection 704, the carbon monoxide content 706, the carbon dioxide content 708, the water content 710, and the signal strength (S.S.) 712 of the off-gas analysis system. Moreover, the interface 700 has a y-axis 720 that illustrates the amount of electric energy (kwh*100) 722, the amount of carbon injected (lbs/min) 724, and the off-gas composition (% volume) for each of the off-gas components. The illustrated off-gas analysis output interface 700 indicates that in the illustrated example heat the carbon is injected in order to generally maintain the carbon monoxide level at a percentage of approximately 12-20 percent. Moreover, the carbon injection also maintains the CO₂ level generally above the 20 percent level. In other embodiments of the invention, the value of CO₂/(CO₂+CO) should be generally kept above a normalized value of greater than 90 or 95 percent (not illustrated in the off-gas analysis system output interface 700). In other embodiments of the invention, the target percentage of the CO and CO₂ in the off-gas and the target value of CO₂/(CO₂+CO) may be inside of these ranges, overlap theses ranges, or be outside of these ranges depending on the type of steel being produced. In some embodiments, the injection of carbon and oxygen is made in order to try to take the CO formed within the EAF 310, and specifically within the slag, into CO₂ as quickly as possible to access as much of the useful energy out of the 2CO+O₂ 2 CO₂ exothermic reaction as early as possible. As such, the level of CO in the off-gas near the beginning of the melting processes should be kept low. As more steel is melted the effects of the conversion of CO to CO₂ is diminished because the heat generated from the conversion does not have as much as an effect when it does not occur near the scrap steel (e.g., conversion occurs above the pool of molten metal and does not pass through scrap steel located above the molted metal if most of the scrap steel is melted). The interface 700 has an x-axis 730 that illustrates the values on the y-axis as a function of processing time 732. As was the case with the slag height level measurement system output interface 600, the processing time may be divided up into stages within the steelmaking process, such as a first melting 740, a second charge of scrap steel 742, a second melting 744, preliminary refining 746, measurements 748, and tapping 750.

FIG. 8 illustrates an overlay interface of the slag height level measurement system output interface 600 and the off-gas analysis system output interface 700. As illustrated, the combined EAF control interface 800 may include the EAF temperature 802, the carbon injection 804, the energy 806, the carbon monoxide content 808, the carbon dioxide content 810, the water content 812, the signal strength 814, and the average slag height 816. Moreover, the interface 800 has a y-axis 820 that illustrates the off-gas temperature (degrees F.) 822 and the off-gas analysis (volume % of the off-gas) 824. The interface 800 has an x-axis 830 that illustrates the values on the y-axis as a function of processing time 832. In addition to the slag height and off-gas analysis measurements previously discussed the interface in FIG. 8 further illustrates the off-gas temperature which helps control the temperatures in the EAF 310 and the H₂O content in the EAF 310, which helps to determine if there is a water leak and potential steam explosion event. In addition the off-gas analysis system may also measure the H₂ content in the off-gas (not illustrated in the interfaces) in order to detect another potential explosion event. If there is an oxidizing atmosphere in the furnace there will be more H₂O in the EAF 310, while if there is a reducing atmosphere there is going to be more H₂ in the EAF 310, which can lead to explosions that may be worse than steam explosions caused by H₂O. Again, as with the slag height interface 700 and off-gas interface, the processing time may be divided up into stages within the steelmaking process, such as a first melting 840, a second charge of scrap steel 842, a second melting 844, preliminary refining 846, measurements 848, and tapping 850.

Multiple processes were run and compared with each other in order to quantify, as least with respect to some sample embodiments, the improvement of the present invention over the prior art. Based on the multiple heats that utilized both the slag height measurement system and the off-gas analysis system a heat profile was developed that reduced the overall cost and time of using the EAF 310 to melt scrap steel. Example 1 illustrated in Table 2 below compares manufacturing steel using traditional test profiles verses the process of the present invention that utilizes a test profile developed based on the analysis from using the slag height measurement system along with the off-gas analysis system during a first heat. As was previously discussed, the slag height measurement system and the off-gas analysis system may be used over time to develop improved heat profiles that can be pre-programmed into the EAF control. Alternatively, or in addition to the pre-programmed heat profile, the slag height measurement system and the off-gas analysis system can be used in real-time or near real time to improve the efficiency of the heat during the steelmaking process within the EAF 310.

In the traditional process, the test profile is used that had been developed over time without the use of the slag height measurement system and/or the off-gas analysis system. The data for the present invention includes using both the slag height level measurement system and the off-gas analysis system to manufacture steel to determine the optimal natural gas, oxygen, and carbon injection amounts and times in order to reduce the costs associated with running the electrodes and minimizing the injection of the natural gas, carbon, and oxygen injection. As illustrated in Table 2, using the present invention over the traditional process resulted in reduced processing time and reduced energy consumption. The energy was reduced in part by the ability to better determine when to reduce the electrode power and/or when the scrap steel became molten in order to turn off the electrodes, and in turn reduce the amount of energy used. In addition the amount of oxygen and carbon injected in the present invention was reduced, while the use of natural gas increased. The costs of running the electrodes during the heat is the greatest, while the carbon injection costs are second, the oxygen injection costs are third, and natural gas costs are fourth. These costs may change over time with changes to these commodity prices, but the present invention may be utilized to change the EAF inputs over time to keep the cost of running a heat to a minimum. As such, while natural gas costs increased the costs of the other three were reduced, and thus, the overall costs associated with running a heat using the present invention is reduced over the traditional process.

TABLE 2
Example 1 Comparing a Traditional Process vs. the Present Invention

| | | | | | Volume | | | | |
|---|---|---|---|---|---|---|---|---|---|
| | | | | Volume | of Nat | Carbon | | | Temp |
| | Charge | P.O.T | Energy | of O₂ | Gas | Injection | Carbon | Oxygen | (deg. |
| Example #1 | (Ton) | (min) | (kwht⁻¹) | (scft⁻¹) | (scft⁻¹) | (lbst⁻¹) | (wt %) | (ppm) | F.) |
| Traditional | 137.7 | 33.6 | 347.3 | 1059 | 109 | 32.4 | 0.04104 | 789 | 3019 |
| Process | | | | | | | | | |
| Present | 138.2 | 32.8 | 338.8 | 1015 | 137 | 22.0 | 0.03751 | 870 | 3021 |
| Invention | | | | | | | | | |
| Difference | | −0.8 | −8.5 | −44 | 28 | −10.4 | −0.00353 | 81 | 2 |

Example 2 illustrated in Table 3 below compares manufacturing steel using a traditional process verses the process of the present invention in another heat. As illustrated in Table 3, similar results were achieved using the present invention over the traditional process.

TABLE 3
Example 2 Comparing a Traditional Process vs. the Present Invention

| | | | | | Volume | | | | |
|---|---|---|---|---|---|---|---|---|---|
| | | | | Volume | of Nat | Carbon | | | |
| | Charge | P.O.T | Energy | of O₂ | Gas | Injection | Carbon | Oxygen | Temp |
| Example #2 | (Ton) | (min) | (kwht⁻¹) | (scft⁻¹) | (scft⁻¹) | (lbst⁻¹) | (wt %) | (ppm) | (deg. F.) |
| Traditional | 139.3 | 33.8 | 344.6 | 1071 | 107 | 35.2 | 0.04140 | 796 | 3033 |
| Process | | | | | | | | | |
| Present | 138.0 | 31.4 | 330.9 | 967 | 127 | 22.5 | 0.03659 | 877 | 3018 |
| Invention | | | | | | | | | |
| Difference | | −2.4 | −13.7 | −104 | 20 | −12.7 | −0.00481 | 81 | −15 |

In order to inject and control the carbon, oxygen, and natural gas into the furnace, a number of different systems may be utilized. In one embodiment, one or more lances may be utilized to inject the carbon, oxygen, and natural gas into the EAF 310. In one embodiment the carbon, oxygen, and natural gas may be injected in a single lance. In other embodiments, the carbon and oxygen, carbon and natural gas, or oxygen and natural gas may be injected through a single lance. In still other embodiments the carbon, oxygen, and natural gas may be injected using separate lances. In one embodiment the oxygen and natural gas may be injected into the EAF 310 through a single lance, while the carbon is injected through a separate system, such as a separate lance or block secured to the wall of the EAF 310, which is coupled to a carbon source. In some embodiments, instead of lances the carbon, oxygen, and/or natural gas may be injected through ports that are operatively coupled to the EAF 310 through other means, such as but not limited to blocks coupled to the EAF 320.

In the embodiment in which the oxygen and natural gas burners are included in a single lance, or in other embodiments, the flow of oxygen into the furnace may be controlled in a number of different ways. In one particular embodiment, the lance may have a main oxygen flow in the center of the lance and secondary oxygen and natural gas shroud flow around the central main flow. In these types of lances there may only be a narrow range over which the oxygen may be adjusted, for example, from 80% to 100% of oxygen flow. The oxygen may be kept in this range in order maintain the necessary flow rate of the oxygen and natural gas into the EAF 310 in order to penetrate the molten metal. In order to reduce the oxygen injected in the EAF 310 the oxygen flow rate may be turned down to the lowest level (e.g., 80% flow) while maintaining the minimum flow rate. If the oxygen needs to be reduced further the natural gas injection may be increased dramatically in order to consume the oxygen being injected into the EAF 310. The natural gas (CH₄) impinges on the oxygen (O₂) and reacts to create heat (CH₄+2 O₂->CO₂+2 H₂O+Heat). As such the amount of oxygen can be decreased, if necessary, by not only turning down the oxygen flow, but by also increasing the natural gas flow. This may also work in reverse if the oxygen injected into the EAF needs to be increased. As such, the oxygen is turned up (e.g., 100%) and the natural gas is turned down to reduce the amount of natural gas that reacts with the oxygen. As such, more oxygen is free to react with the carbon to foam the slag within the EAF 310. In other embodiments of the invention the range of the flow of oxygen may be within, outside of, or overlap the 80%-100% described above, but would operate in the same way as described herein.

Specific embodiments of the invention are described herein. Many modifications and other embodiments of the invention set forth herein will come to mind to one skilled in the art to which the invention pertains, having the benefit of the teachings presented in the foregoing descriptions and the associated drawings. Therefore, it is to be understood that the invention is not to be limited to the specific embodiments disclosed and that modifications and other embodiments and combinations of embodiments are intended to be included within the scope of the appended claims. Although specific terms are employed herein, they are used in a generic and descriptive sense only and not for purposes of limitation.

What is claimed is:

1. A method of manufacturing steel, comprising:
monitoring a slag height level in the EAF using a slag height measurement system;
monitoring a carbon indicator level exiting the furnace in real-time or near-real time using an off-gas analysis system;
determining to increase carbon or oxygen injected into the EAF when the slag height level is below a slag height threshold level and the carbon indicator level is below a carbon indicator threshold level to return the carbon indicator level to above the carbon indicator threshold level, and to return the slag height level to above the slag height threshold level; and
determining to decrease the carbon or the oxygen injected into the EAF when the slag height level is below the slag height threshold level and the carbon indicator level is above the carbon indicator threshold level to maintain the carbon indicator level above the carbon indicator threshold level, and to return the slag height level to above the slag height threshold level.

2. The method of claim 1, wherein the slag height measurement system comprises one or more vibration sensors coupled to the EAF.

3. The method of claim 1, wherein the off-gas analysis system comprises an off-gas laser sensor located on an exit of the EAF or on an exhaust duct coupled to the exit of the EAF.

4. The method of claim 1, wherein monitoring the carbon indicator level in real-time or near-real time comprises monitoring a carbon monoxide level, a carbon dioxide level, or a combined carbon monoxide and carbon dioxide level; and receiving the carbon monoxide level, carbon dioxide level, or combined carbon monoxide and carbon dioxide level measurements within 10 seconds.

5. The method of claim 1, wherein determining to increase the carbon or the oxygen injected into the EAF comprises:
determining to increase the carbon injected into the EAF first and determining if the carbon indicator level returns to above the carbon indicator threshold level; and
determining to increase the oxygen injected when injecting the carbon into the EAF does not return the carbon indicator level to above the carbon indicator threshold level.

6. The method of claim 1, wherein determining to decrease the carbon or the oxygen injected into the EAF comprises:
determining to decrease the carbon injected into the EAF first and determining if the carbon indicator level remains above the carbon indicator threshold level; and
determining to decrease the oxygen injected when decreasing the carbon injected into the EAF fails to maintain the carbon indicator level above the carbon indicator threshold level or does not return the slag height to above the slag height threshold level.

7. The method of claim 1, further comprising:
determining when the scrap steel has substantially melted into a molten pool of metal by monitoring the carbon indicator level, the slag height level, and an arc stability measurement.

8. The method of claim 7, wherein determining when the scrap steel has substantially melted into a molten pool of metal by monitoring the carbon indicator level, the slag height level, and an arc stability measurement comprises:
determining when the carbon indicator level in the off-gas has plateaued;
determining when the slag height level has plateaued; and
determining when the arc stability measurement meets a desired arc stability measurement level.

9. The method of claim 1, wherein increasing the oxygen comprises increasing the flow of oxygen in a burner and decreasing the flow of natural gas to reduce the oxygen consumed by combustion of the natural gas resulting in an increase in the oxygen to the EAF; and decreasing the oxygen comprises decreasing the flow of the oxygen in the burner and increasing the flow of the natural gas to increase the oxygen consumed by combustion of the natural gas resulting in a decrease in the oxygen to the EAF.

10. The method of claim 1, wherein monitoring the slag height level and the carbon indicator level is used to adjust the carbon and the oxygen injection in real-time or near real time during the steelmaking process or to determine a pre-programmed profile for the carbon and the oxygen injection.

11. A system for manufacturing steel, comprising:
a furnace;
a slag height level measurement system operatively coupled to the furnace, wherein the slag height level measurement system is used to monitor a slag height level in the furnace;
an off-gas analysis system operatively coupled to the furnace, wherein the off-gas analysis system is used to monitor a carbon indicator level exiting the furnace in real-time or near-real time;
wherein when the slag height level is below a slag height threshold level and the carbon indicator level is below a carbon indicator threshold level, determining to increase carbon or oxygen added to the furnace to return the carbon indicator level to above the carbon indicator threshold level, and to return the slag height level to above the slag height threshold level; and
wherein when the slag height level is below the slag height threshold level and the carbon indicator level is above the carbon indicator threshold level, determining to decrease the carbon or the oxygen added to the furnace to maintain the carbon indicator level above the carbon indicator threshold level, and to return the slag height level to above the slag height threshold level.

12. The system of claim 11, wherein the slag height level measurement system comprises one or more vibration sensors coupled to the furnace.

13. The system of claim 11, wherein the off-gas analysis system comprises an off-gas laser sensor located on an exit of the EAF or on an exhaust duct coupled to the exit of the EAF.

14. The system of claim 11, wherein monitoring the carbon indicator level in real-time or near-real time comprises monitoring a carbon monoxide level, a carbon dioxide level, or a combined carbon monoxide and carbon dioxide level; and receiving the carbon monoxide level, carbon dioxide level, or combined carbon monoxide and carbon dioxide level measurements within 10 seconds.

15. The system of claim 11, wherein increasing the carbon or the oxygen injected into the furnace comprises:
determining to increase the carbon injected into the EAF first and determining if the carbon indicator level returns to above the carbon indicator threshold level; and
determining to increase the oxygen injected when injecting the carbon into the EAF does not return the carbon indicator level to above the carbon indicator threshold level.

16. The system of claim 11, wherein decreasing the carbon or the oxygen injected into the furnace comprises:
determining to decrease the carbon injected into the EAF first and determining if the carbon indicator level remains above the carbon indicator threshold level; and
determining to decrease the oxygen injected when decreasing the carbon injected into the EAF fails to maintain the carbon indicator level above the carbon indicator threshold level or does not return the slag height to above the slag height threshold level.

17. The system of claim 11, further comprising:
an arc stability measurement system, and wherein the off-gas analysis system, the slag height measurement system, and the arc stability measurement system are used to determine when the scrap steel has substantially melted into a molten pool of metal bay monitoring the carbon indicator level, the slag height level, and an arc stability measurement.

18. The system of claim 17, wherein determining when the scrap steel has substantially melted into the molten pool of metal comprises determining when the carbon indicator level in the off-gas has plateaued; determining when the slag height level has plateaued; and determining when the arc stability measurement meets a desired arc stability measurement level.

19. The system of claim 11, wherein increasing the oxygen comprises increasing the flow of oxygen in a burner and decreasing the flow of natural gas to reduce the oxygen consumed by combustion of the natural gas resulting in an increase in the oxygen to the EAF; and decreasing the oxygen comprises decreasing the flow of the oxygen in the burner and increasing the flow of the natural gas to increase the oxygen consumed by combustion of the natural gas resulting in a decrease in the oxygen to the EAF.

20. The system of claim 11, wherein monitoring the slag height level and the carbon indicator level is used to adjust the carbon and the oxygen injection in real-time or near real time during the steelmaking process or to determine a pre-programmed profile for the carbon and the oxygen injection.

21. A method of manufacturing steel, comprising:
monitoring a slag height level in a furnace using a slag height measurement system;
monitoring a carbon indictor level in the furnace in real-time or near-real time using an off-gas analysis system;
using the slag height level and the carbon indicator level to determine when the scrap steel has substantially melted into a molten pool of metal.

22. A system for manufacturing steel, comprising:
a furnace;
a slag height level measurement system operatively coupled to the furnace, wherein the slag height level measurement system is used to monitor a slag height level in the furnace;
an off-gas analysis system operatively coupled to the furnace, wherein the off-gas analysis system is used to monitor a carbon indicator level exiting the furnace in real-time or near-real time; and
wherein the slag height level and the carbon indicator level are used to determine when the scrap steel has substantially melted into a molten pool of metal.
